(19) United States
(12) Patent Application Publication
(10) Pub. No.: US 2020/0118217 A1
(43) Pub. Date: Apr. 16, 2020

(54) SYSTEMS AND METHODS FOR UNDERWRITING DILIGENCE

(71) Applicant: Lumesis, Inc., Stamford, CT (US)

(72) Inventors: Gregg L. Bienstock, Larchmont, NY (US); Timothy J. Stevens, Stamford, CT (US)

(73) Assignee: Lumesis, Inc., Stamford, CT (US)

(21) Appl. No.: 16/713,692

(22) Filed: Dec. 13, 2019

Related U.S. Application Data
(63) Continuation of application No. 15/092,049, filed on Apr. 6, 2016, now abandoned.

(51) Int. Cl. G06Q 40/08

(52) U.S. Cl. CPC G06Q 40/08

(57) ABSTRACT

A multi-faceted tool to support regulatory compliance and business efficiency for those involved in the underwriting of municipal bonds is described” Provided is a computer system and process providing for a configurable workflow and deal file solution that allows a user to effectively and efficiently meet their requirements under 15c2-12 and MSRB Rule G-27. The present invention aggregates required data and information, stores the same, provides for the analysis of critical filing information for municipal underwritings and provides the user deal file storage.

### CROSS-REFERENCE TO RELATED APPLICATIONS

This application is a continuation of U.S. Ser. No. 15/092,049, filed Apr. 6, 2016, which is incorporated herein by reference in its entirety.

### FIELD OF THE INVENTION

The disclosed embodiments generally relates to underwriting diligence obligations, and more particularly, to underwriting diligence obligations and compliance support to underwriters of municipal bonds/securities.

### BACKGROUND OF THE INVENTION

In March 2012, the SEC's Office of Compliance Inspections and Examinations issued a National Examination Risk Alert focused on the potential risk to investors in municipal bonds. The Risk Alert can be summarized such that an underwriter, by virtue of its role, is representing that it has a reasonable belief about the truthfulness and completeness of key representations made in disclosure documents used in the offering. Rule 15c2-12 requires the underwriter, prior to bidding for or purchasing securities in connection with the offering to: 1) obtain and review a deemed final official statement in connection with the offering; 2) reasonably determine that the issuer or obligor has undertaken, in writing, to provide the MSRB with continuing disclosures; 3) in negotiated and competitive deals, review the issuer's or obligor's disclosures in a professional manner with respect to accuracy and completeness of statements re the offering; 4) evaluate the likelihood that an issuer or obligor will comply on a timely basis with disclosure undertakings; and 5) obtain evidence reasonably sufficient to determine whether and when annual filings and event notices were provided (citing EMMA and municipal securities repositories as places to look).

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a multi-faceted tool to support regulatory compliance and business efficiency for those involved in the underwriting of municipal bonds is described. In an illustrated embodiment, provided is a computer providing for a configurable workflow and deal file solution that allows a user to effectively and efficiently meet their requirements under 15c2-12 and MSRB Rule G-27. The application aggregates all required data and information, stores the same, provides for the analysis of critical filing information for municipal underwritings and provides the user deal file storage.

### BRIEF DESCRIPTION OF THE DRAWINGS

The accompanying appendices and/or drawings illustrate various non-limiting, example, inventive aspects in accordance with the present disclosure:

FIG. 1 illustrates an example communication network;

FIG. 2 illustrates an example network device/node; and

FIGS. 3A-3C are GUI screenshots of the Ipreo Calendar;

FIG. 4 depicts a GUI screen shot illustrating various menu selections;

FIG. 5 depicts a GUI screen shot illustrating a Deal Administration page selected from the GUI of FIG. 4;

FIG. 6 depicts a GUI screen shot illustrating a Deal Details page selected from the GUI of FIG. 4;

FIG. 7 depicts a GUI screen shot illustrating a POS/OS page selected from the GUI of FIG. 4;

FIG. 8 depicts a GUI screen shot illustrating a Current CDA Details page selected from the GUI of FIG. 4;

FIG. 9 depicts a GUI screen shot illustrating a CD Look Book page selected from the GUI of FIG. 4;

FIGS. 10A and 10B are GUI screen shots of Continuing Disclosure Obligated Party pages;

FIG. 11 is a screen shot depicting an Annual Financial Information Operating Data Analysis;

FIG. 12 is a screen shot depicting an Issue Audit Analysis tab from FIG. 10A;

FIG. 13 is a screen shot depicting a Historical OS Docs tab from FIG. 10A;

FIG. 14 is a screen shot depicting a Disclosure Filings tab from FIG. 10A;

FIG. 15 is a screen shot depicting a Summary tab from FIG. 10A;

FIG. 16 is a screen shot depicting an Obligor Profile tab from FIG. 10A;

FIG. 17 is a screen shot depicting an Economic Data;

FIG. 18 is a screen shot depicting a Deal Docs tab from FIG. 4;

FIG. 19 is a duplicative screenshot of FIG. 4; and

FIG. 20 is a screen shot depicting History tab from FIG. 19.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

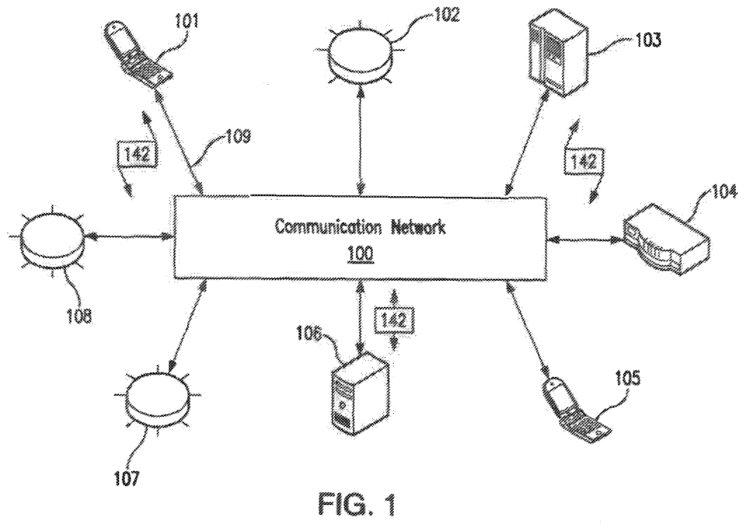

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java. Smalltalk. C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

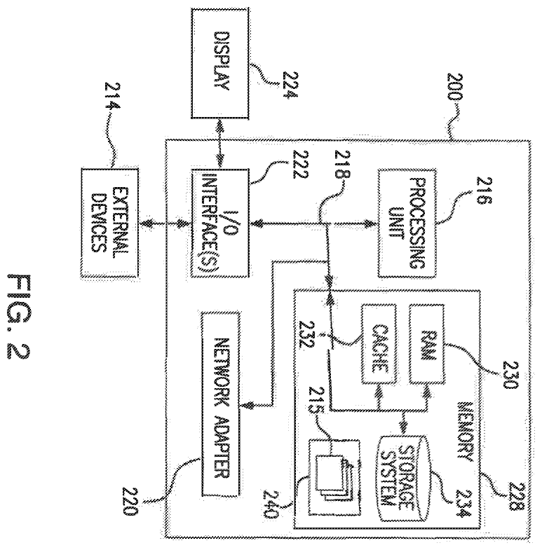

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the present invention. Device 200 is only one example of a suitable system and is not intended to suggest any limitation as to the scope of use or functionality of embodiments of the invention described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more IS processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, nonvolatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 215, such as underwriting diligence module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the invention as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present invention may be implemented. FIGS. 1 and 2 are exemplary of a suitable environment and are not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With the exemplary communication network 100 (FIG. 1) and computing device 200 (FIG. 2) being generally shown and discussed above, description of certain illustrated embodiments of the present invention will now be provided which is to be implemented on computing device 200 in network 100. It is to be appreciated described below is a description of an underwriter's diligence obligations and a firm's supervisory obligations under 15c2-12 and MSRB Rule G-27, respectively. These “rules” are a primary basis for the one or more illustrated embodiments. It is to be understood Rule 15c2-12 of the Securities Exchange Act sets forth certain broker-dealer obligations when participating in an underwriting (1989). “The Commission also provided interpretive guidance . . . under the anti-fraud provisions of the federal securities laws to form a “reasonable basis” [due diligence] for offering new issues . . . “In 2010, the SEC amended the rule to “enhance the quality and timeliness . . . and to update the interpretive guidance regarding the obligations of underwriters.”

With regards to supervisory obligation, MSRB Rule 27 is the supervisory component requiring, amongst other things, that broker-dealers establish and maintain a system of supervision for compliance with 15c2-12. This includes: 1) written policies and procedures; 2) annual testing or exams; 3) submission of a report and summary of the testing or exam results to senior management; and 4) any amendments to policies in light of the results.

Regarding exams, focus is on compliance with due diligence under 15c2-12 and the supervisory obligation is to the factors highlighted above. Relevant to the exam staff is evidence that broker-dealers have: 1) created and maintained an adequate supervisory system and policies setting forth diligence obligations; and 2) adequate evidence of performance of obligations under 15c2-12. MSRB Rules and anti-fraud provisions.

It is to be appreciated that failure to comply with the diligence obligation can lead to a violation of the anti-fraud provisions of federal securities laws, Rule 15c2-12 and MSRB rules. Penalties for supervisory failures include sanctions on a firm and/or person—the failure is defined as the supervisor “that fails to reasonably supervise a person subject to their supervision that violates the federal securities law.” There is an affirmative defense where “reasonable procedures and systems” have been established and implemented. To rely on the defense, the broker-dealer must develop a system for implementing its procedures “that could reasonably be expected to prevent and detect securities law violations . . . . It is necessary to implement measures to monitor compliance with those policies and procedures and an appropriate system of follow-up and review if red flags are detected.”

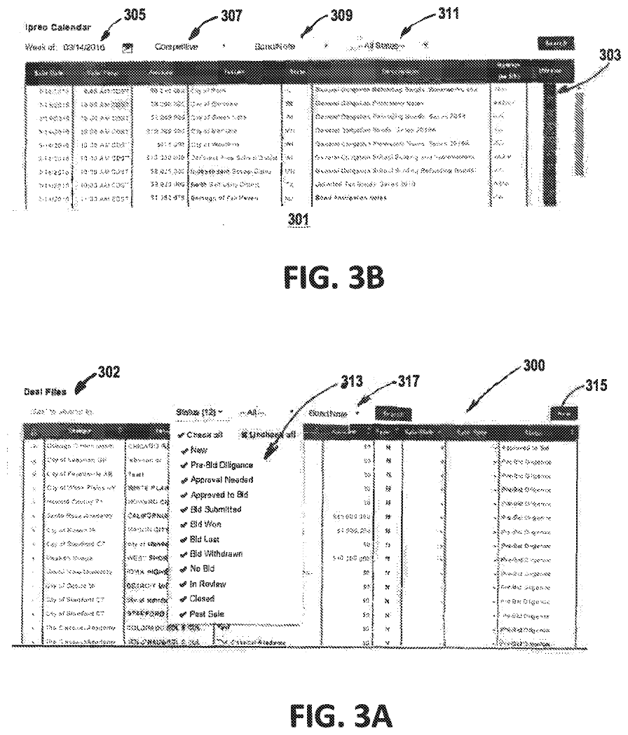

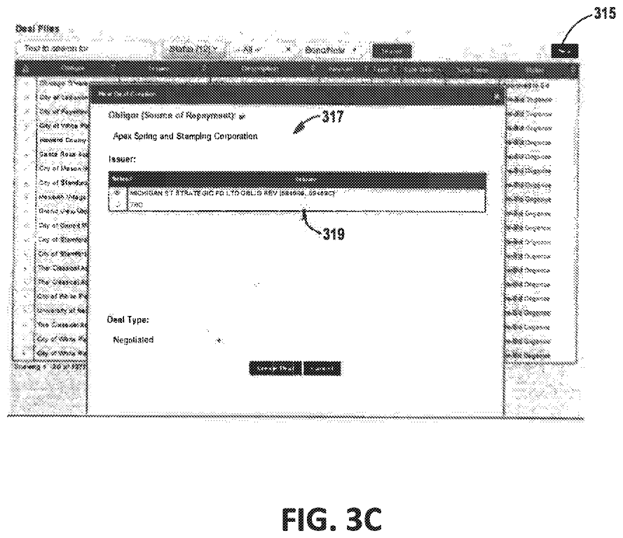

With regard to the one or more illustrated embodiments of the present invention, it is to be understood a platform executing on computer 200 preferably enables ease of incorporation of unique client requirements and workflow which will drive several additional detail aspects of the platform, which is preferably web-based and accessed via user name and password. Functionality includes, but is not limited to, upon log-in, a user is presented with the screen 300 depicted in FIG. 3A depicting exemplary grid headers and exemplary data. With reference to FIG. 3B, shown is an exemplary “Ipreo Calendar” 301 (FIG. 3A) which is a permissioned recreation of the municipal forward calendar of new deals. “Deal Files” 302 of FIG. 3A, are the files of deals created and stored and where the User creates a new deal not provided for on the Ipreo calendar.

With regard to the Ipreo Calendar 301, it is to be appreciated that a permissioned user is provided access to the forward deal calendar 301, enabling a user to select deals by date 305, deal type (competitive or negotiated) 307, bond or note 309 and/or by State 311. The user can selects the “D” icon 303 to create a deal file.

From the “Deal Files” screen (FIG. 3A), the user can search for deals by name, by status 313 and by bond or note (preferably via drop-down box 317). It is to be appreciated that the user has access to deals in progress, deals to be underwritten and deals previously underwritten within the user's organization. A user can preferably commence a “New” file 315, continue an open review, and otherwise access deals based on the drop down 313. Once the deal or obligor is identified, the user can select a pre-existing deal.

With reference now to FIG. 3C, a “New UW” button 315 on the Deal Files screen allows the user to create a new UW file or case. If the user selects “new” 315, the user can enter an obligor name 317. Upon entry of the name, a list of issuers for that obligor are presented 319, preferably along with a “TBD” option in the event the obligated party has not yet identified the issuer. Once the issuer is selected, the user identifies the deal as negotiated or competitive.

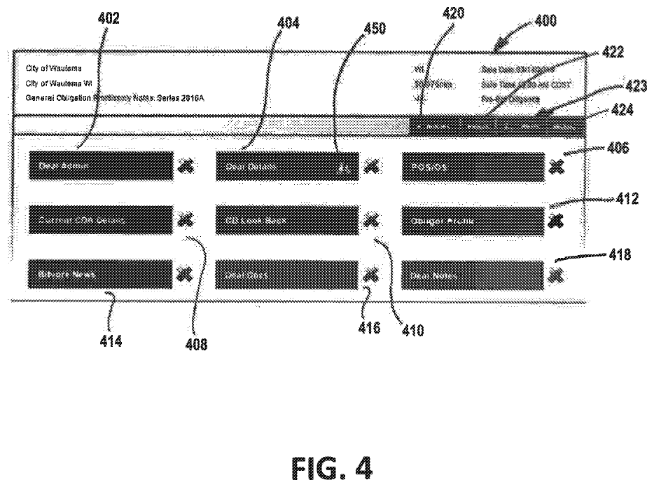

With reference now to screen 400 of FIG. 4, when a user creates a New Deal 315 or clicks “D” 303 on the calendar (FIG. 3B), a “deal File” is created (e.g., City of Wautoma) or caused to be provided whereby the user is accessing an existing file (in progress or closed) or creating a new file. For instance, the tab name represents an Issuer 400 and, in the current example, is labeled “City of Wautoma”. Preferably, the Deal File 400 has embedded tabs within it labeled, for example: “Deal Admin” 402, “Deal Details” 404, “POS/OS” 406. “Current CDA Details” 408, “CD Look Back” 410, “Obligor Profile” 412, “News” 414, “Deal Docs” 416 and “Deal Notes” 418. Tabs are also provided for “Actions” 420 which include “No Bid” and “Close”. “Report” 422 enables a user to generate a configurable report or a report from pre-set template of the referenced file. “History” 424 provides user access to a history of all actions associated with the deal.

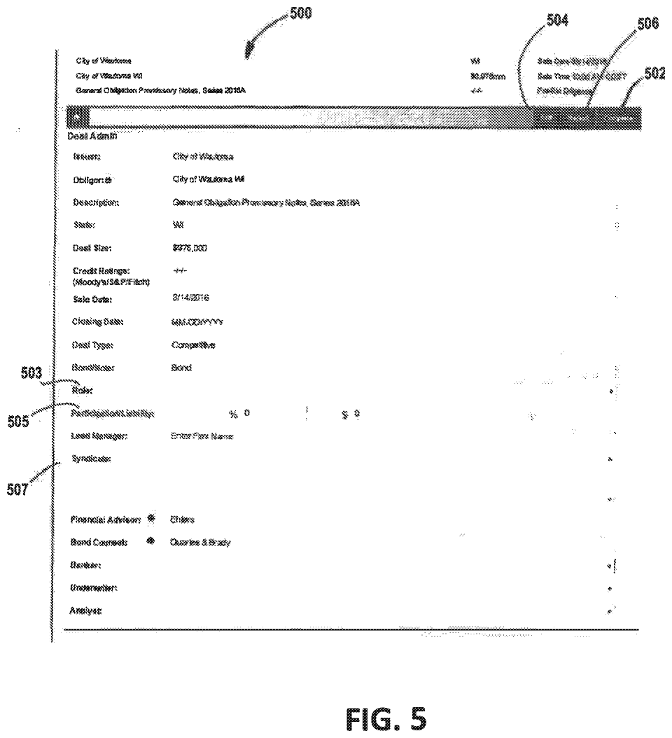

With reference now to the screen 500 of FIG. 5, a user has selected “Deal Administration” 402 (FIG. 4), which contains pre-populated and auto-populated information and allows the user to enter information about their role on the deal 503, participation 505, syndicate member's 507 (preferably from a drag and drop screen where other firms are identified) and deal participants from their firm (preferably from a custom configured drop down). The Financial Advisor and Bond Counsel are either auto-populated or can be entered from a pick-list by the user. The user can select, via a pick list, the Banker, Underwriter and Analyst, as applicable. This screen 500 allows the user to “Complete” 502 their work (preferably causing the red “X” that appears next to each deal module to convert to a green check mark), attesting to their completion 502, edit the file after completion 504 and to create a report 506 of just this section.

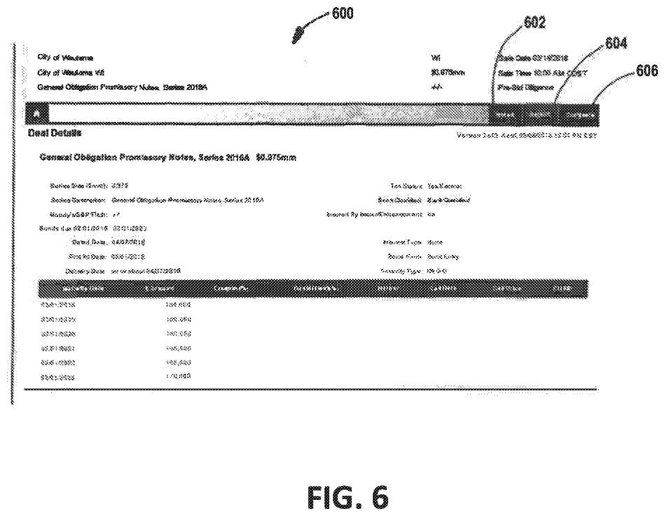

With reference now to the screen 600 of FIG. 6, a user has selected “Deal Details” 404 (FIG. 4), which preferably contains auto-populated data regarding the current deal, including, but not limited to, Series Size, Description, Ratings. Tax Status, Bank Qualified. Insurance, Dated Date. Interest Date, Delivery Date, Interest Type, Bond Form, Security Type and, for each bond associated with the issue, the Maturity Date, Amount, Coupon, Basis/Yield, Insurer, Call Details, Call Price and CUSIP. It is to be appreciated that, as the deal progresses and data is changed or updated by the data provider, the Deal Details are automatically updated. The user will preferably receive an alert via email and on screen as depicted in FIG. 4 by the hazard symbol 450 and the alert box 423, and be preferably prompted to review the same and accept or reject the updates. It is to be understood a user can add notes 602, generate a report 604 of this section and to “Complete” 606 their work (preferably causing the red “X” next to each deal module to convert to a green check mark) attesting to their completion and edit the file after completion.

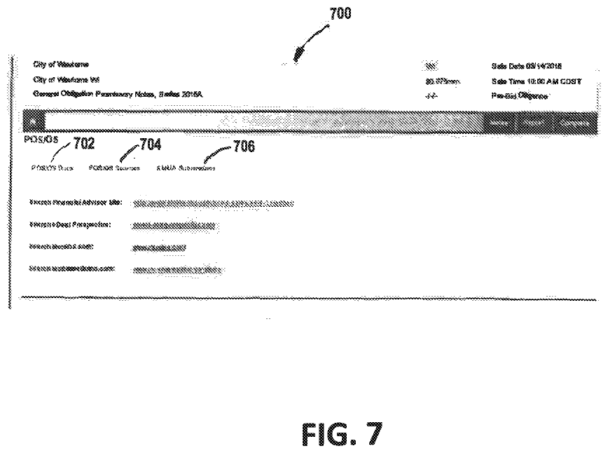

With reference now to the screen 700 of FIG. 7, a user has selected “POS/OS” 406 (FIG. 4) and is provided preferably with three tabs 702, 704 and 706. Tab 702 enables a user to upload a Preliminary Official Statement and the Official Statement. It is to be appreciated that a user can upload multiple version of the aforesaid documents and can access all history by selecting a “History” button provided via user selection of tab 702. In particular, selection of tab 704 (as shown) provides the user with a list of sources where the POS may be found and preferably includes the Financial Advisor on the selected deal and preferably links to the I-Deal Prospectus, MuniOS, McElwee Quinn, Meritos.com, and MuniHub sites. A third tab 706. “EMMA Submissions” provides the user with the final OS as the same is filed with the MSRB and is preferably auto-populated. It is to be appreciated that the user can add notes, generate a report of this section (including live links to any uploaded or stored documents) and to “Complete” their work (preferably causing a red “X” next to each deal module to convert to a green check mark), attesting to their completion and edit the file after completion.

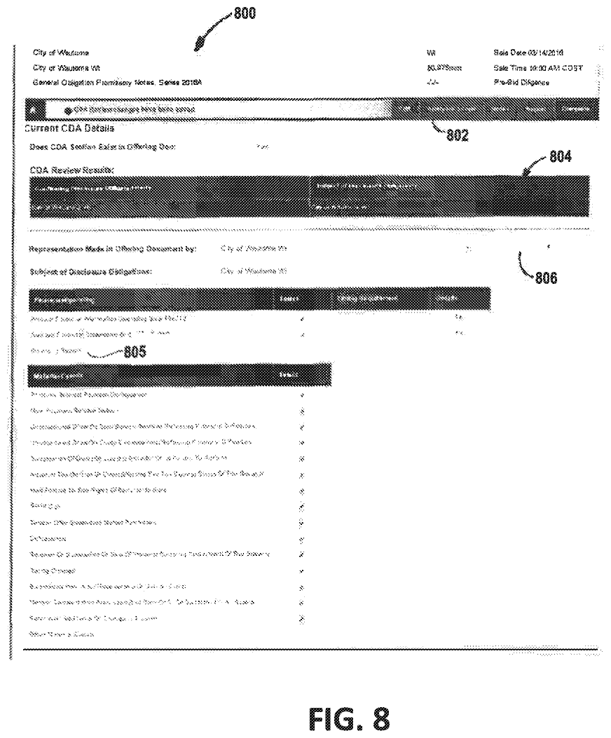

With reference now to the screen 800 of FIG. 8, a user has selected “Current CDA Details” 408 (FIG. 4) where the user or Lumesis preferably enters information about the representations and requirements set forth in the current deal (“CDA” refers to the Continuing Disclosure Agreement and is hereinafter referred to as the “CDA”). The user or the system provider preferably answers if the offering document contains a CDA section 806. If no, the user or Lumesis selects if the deal is “Exempt from Rule 15c2-12” or not. If yes, the user is provided with a drop down menu of possible basis for exemption 806.

It is to be appreciated that if the Offering Document contains a CDA section, the Continuing Disclosure Obligated Party (“CDOP”) and Subject of Disclosure Obligation is auto-populated 804. The user or Lumesis can add additional CDOP, and/or Subjects of the Disclosure Obligation, as needed. The user or Lumesis can select as to what the representations have been made by the obligor in the Offering Document (e.g., Full Compliance. Exceptions . . . with a drop down of exceptions to be noted) and as to No Representations Made 806. The user can then enter the timing requirements for Audit or CAFR and the timing requirements and detailed financial and operating data requirements for the Annual Financial Information Operating Data, and the interval at which the filings are to be made 805. The “Material Events” are preferably auto-selected for the user.

In accordance with the illustrated embodiment, the user can expand the analysis scope by selecting the “Analysis Scope” button 802 thereby allowing the user to include in their analyses, obligations of the obligated party for issuers that are distinct from the issuer on the current deal. It is to be understood the user may also add notes, generate a report of this section (including live links to any uploaded or stored documents) and to “Complete” their work (causing the red “X” next to each deal module to convert to a green check mark), attesting to their completion and edit the file after completion.

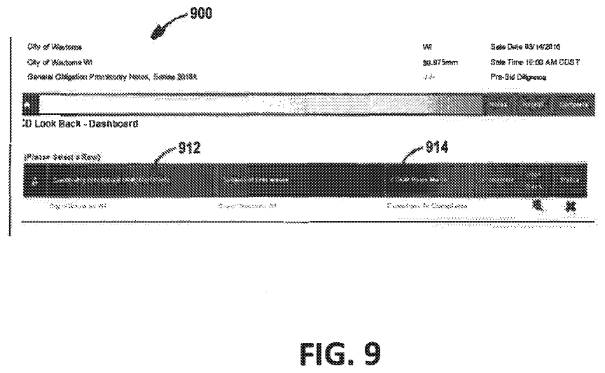

With reference now to the screen 900 of FIG. 9, a user has selected “CD Look Back” 410 (FIG. 4) and the “CD Look Back—Dashboard” is displayed showing the Continuing Disclosure Obligated Party (Parties, as applicable) 912 and Subject(s) Disclosure (b) are listed with the CDOP Reps Made 914 in the document reviewed in the preceding section. The status of the user's review is preferably provided (c).

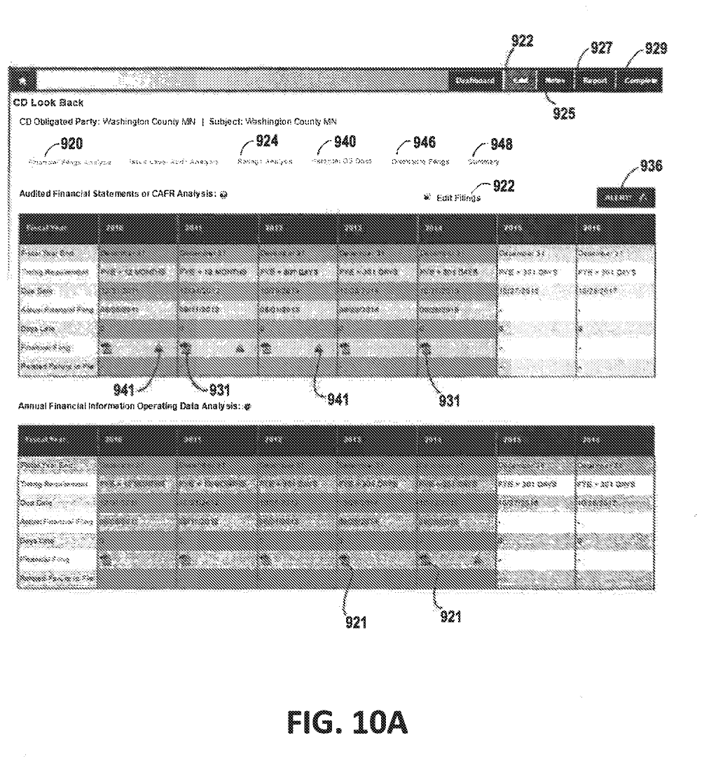

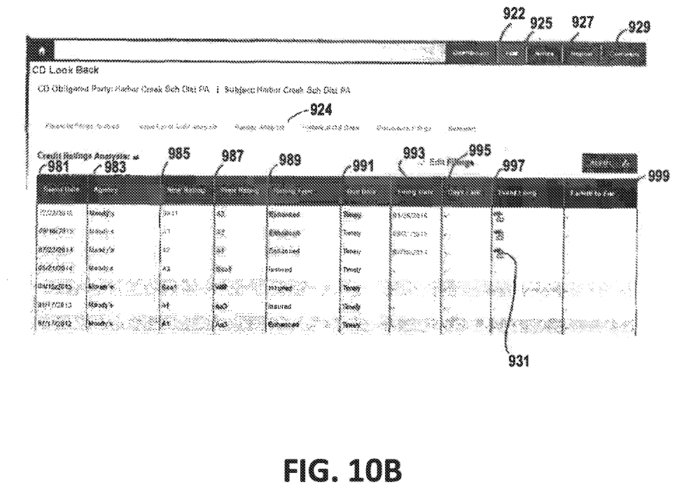

With reference now to FIGS. 10A and 10B, a user has selected the Continuing Disclosure Obligated Party 912 (FIG. 9) and is preferably brought to the first tab, and exceptions at tab 920 (FIG. 10A), that provides the user a listing of the exceptions identified for the analyses conducted (a) at the Issue Level allowing the user click any row to navigate to the related analysis tab for additional details. This Exceptions tab identifies for the user the Issue. Dated Date of the Issue, the type of obligation, the applicable period and allows the user to enter notes.

With reference now to FIG. 10B, a User has selected the “Ratings Analysis” tab 924 that provides the user an analysis of rating agency rating changes for the obligated party and if the obligated party timely filed a required material event filing with the MSRB or not. The user is provided the event date of the rating action 981, the agency 983, the new rating 985, prior rating 987, rating type 989, the issue(s) affected by the rating (a), due date for the required MSRB filing 991, the actual if any, filing date 993, days late 995, and as applicable, a link to the actual event filing 997. This information is preferably presented in the “stop-light” format with missed filings noted in red and late filings in yellow. The user is notified if a filing has been done but a bond or bonds have been missed on a particular issue by a red “c” indicator (b) and can see bond level compliance by selecting the “Bond Level” tab (c) which generates an excel file of all outstanding bonds and highlights in red those bonds where a required filing has not been made. The user is notified of circumstances where a filing has been made but the system provider does not give credit for the same by a red flag indicator (d). The user can click on the red flag to gain the benefit of an explanation of why credit was not given. It is to be understood the user may also add notes 925, generate a report of this section 927 (including live links to any uploaded or stored documents) and to “Complete” their work 929 (causing the red “X” next to each deal module to convert to a green check mark), attesting to their completion and edit the file after completion.

Continuing with reference to FIGS. 10A and 10B, the user is preferably provided with auto-populated data and, if the user selects, user populated data. The display preferably generates a “stop light report” informing the user if the filings were timely (green), late (yellow) or missing (red). Selecting a PDF icon 931 in FIG. 10B (and 921 in FIG. 10A) allows the user to generate a stored version of the referenced document. The user is provided with links to the filings, if made, and in the event the filing was misclassified with the MSRB, the user is notified of the same by preferably the inclusion of a blue triangle sign 941 in FIG. 10. The user can opt to edit the filings analysis by selecting the “Edit Filings” box 922 thereby allowing the user to review all filings made by the obligated party with the MSRB and to reclassify the same. It is to be appreciated that the user can add notes 925, generate a report of this section 927 (including live links to any uploaded or stored documents) and to “Complete” their work 929 (causing the red “X” next to each deal module to convert to a green check mark), attesting to their completion and edit the file after completion.

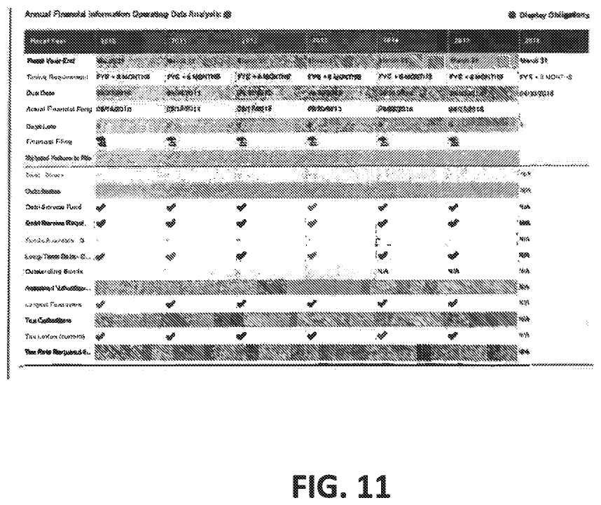

As show in FIG. 11, where the Operating Data requirements are identified, additional analysis is preferably provided identifying the obligations, the associated year in which the obligations was for and if it was completed or not. The user can select the Operating Data item or check mark and display an image of the data filing requirement. It is to be appreciated that the user can add notes, generate a report of this section (preferably including live links to any uploaded or stored documents) and to “Complete” their work (preferably causing the red “X” next to each deal module to convert to a green check mark), attesting to their completion and edit the file after completion.

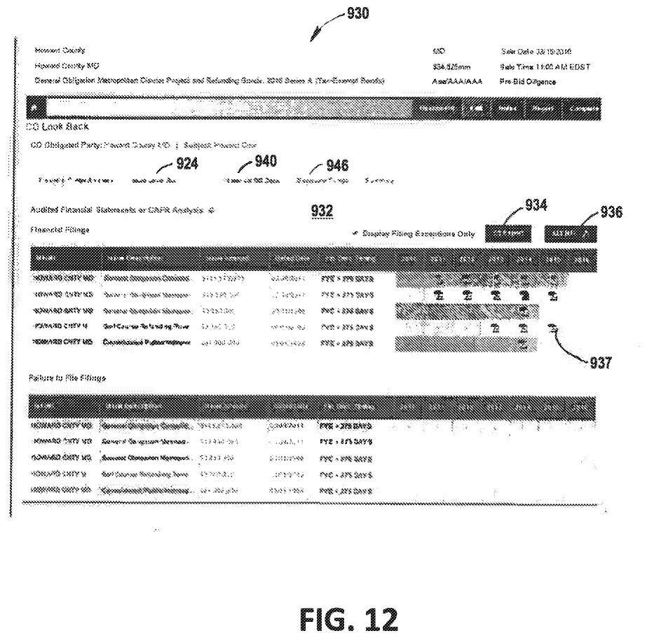

As shown in screen 930 of FIG. 12, the user selected the Issue Level Audit Analysis tab 924 (FIG. 10) and is preferably provided a stop light report table 932 that identifies issues outstanding for the obligated party at times during a prescribed time period (e.g., five years), as required by 15c2-12, and if the Audited Financial Statements or CAFR and any associated “Failure to File” filing was timely filed or filed at all. Selecting the PDF icon 937 allows the user to generate a stored version of the referenced document. The user is provided a “C9Export” tab 934 that allows the user to generate a report identifying every CUSIP 9 outstanding and if the Audited Financial Statement or CAFR and any associated “Failure to File” filing was made or not with those missing the required filing highlighted in red. It is to be understood the user can add notes, generate a report of this section (including live links to any uploaded or stored documents) and to “Complete” their work (causing the red “X” next to each deal module to convert to a green check mark), attesting to their completion and edit the file after completion.

With respect to FIGS. 10A and 12, the user is preferably presented with an “Alert” button 936 that notifies them if any outstanding issue has not yet been reviewed for purposes of creating the above-referenced stop light reports (as referenced in FIGS. 10A. 10B, 11, 12).

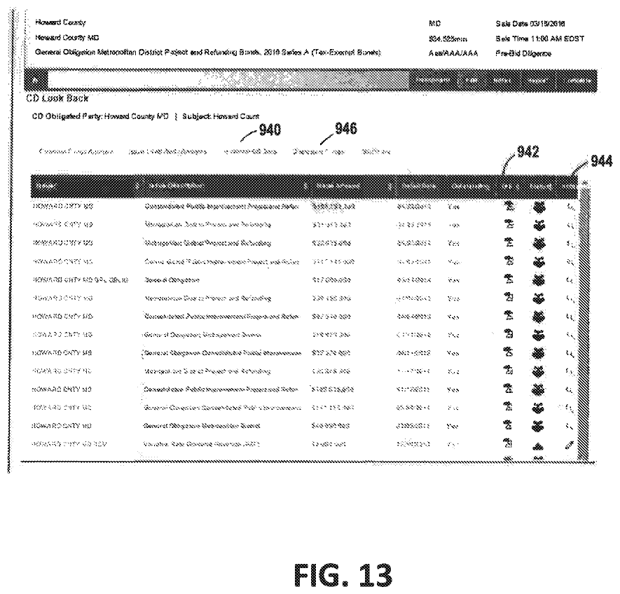

As shown in FIG. 13, the user has selected the “Historical OS Docs” tab 940 that preferably displays all debt for the obligated party that was outstanding at any time in the preceding five years. The user is provided a link to a PDF 942 of the OS, whether the debt is still outstanding, the status, if the deal has been reviewed or review is needed and the opportunity to review work previously done or conduct a review by the user 944. Deals not yet reviewed are preferably identified, in the “Status” column of FIG. 13, with a yellow triangle and deals reviewed preferably with three blue heads. The user can also select an icon 944 in the “Action” column allowing the user to edit or insert the information for each deal as was done for the Current CDA Details module described above. It is to be further understood that the user can add notes, generate a report of this section (including live links to any uploaded or stored documents) and to “Complete” their work (preferably causing the red “X” next to each deal module to convert to a green check mark), attesting to their completion and edit the file after completion. The Completion for the obligated party is distinct from completion of the overall module as there can be multiple obligated parties per deal. The results of the analysis performed in this section are, upon completion, “frozen” in time as a PDF file.

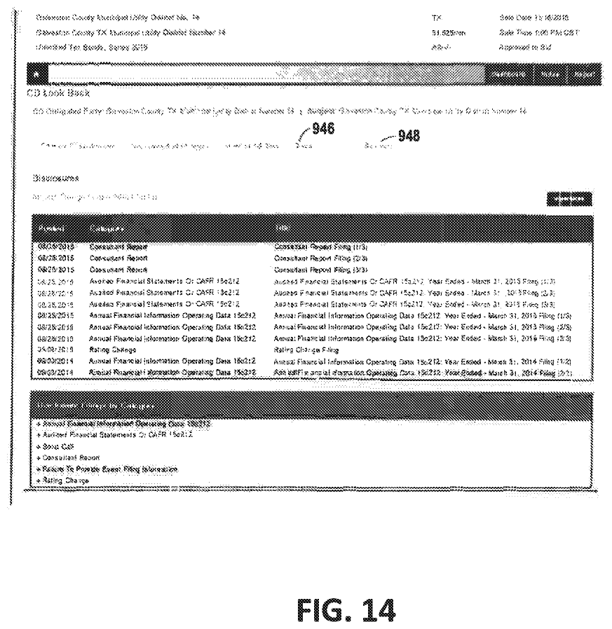

As shown in FIG. 14, the user has selected the Disclosure Filings tab 946 (FIG. 10) which preferably displays disclosure filings made by or on behalf of the obligated party to the MSRB. For instance, in the exemplary illustration provided, the tables provide all filings made since Jun. 1, 2009 and the filings are sorted chronologically and by disclosure category and, by selecting any category or document, the user can display the contents of the same. The user can add notes, generate a report of this section (including live links to any uploaded or stored documents) and to “Complete” their work (causing the red “X” next to each deal module to convert to a green check mark), attesting to their completion.

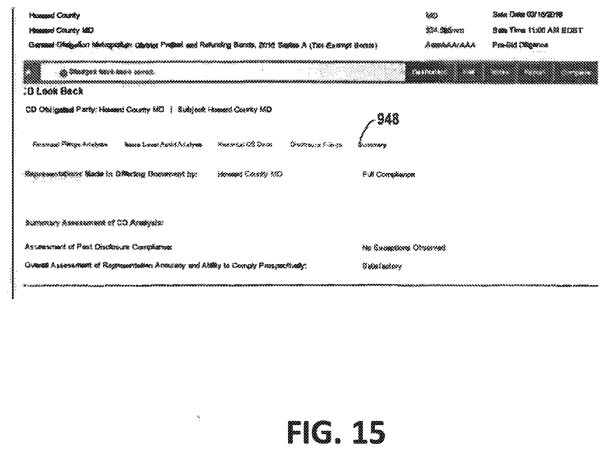

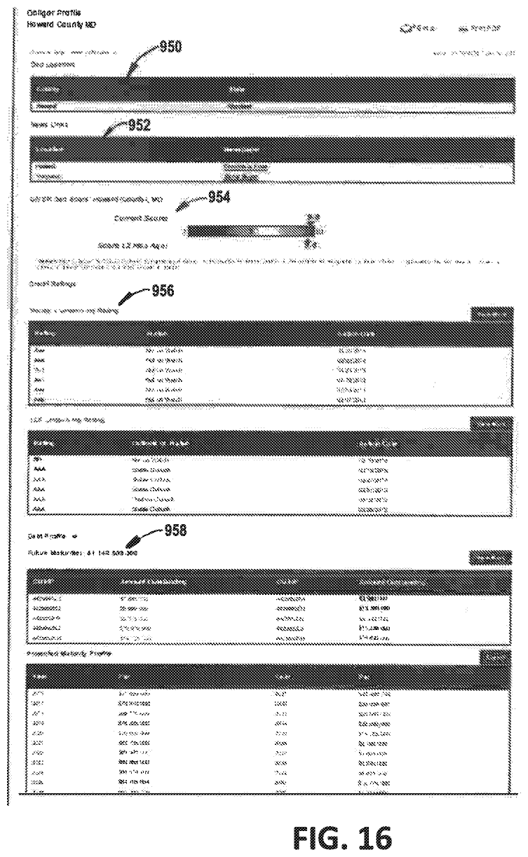

As shown in FIG. 15, the user has selected the “Summary” tab 948 where the User records preferably their assessment of the Continuing Disclosure Analysis of the obligated party by indicating their assessment of past disclosure compliance and their perspective as to the ability of the obligated party to comply prospectively. The user can add notes, generate a report of this section and to “Complete” their work (e.g., preferably causing the red “X” next to each deal module to convert to a green check mark), attesting to their completion and edit the file after completion.

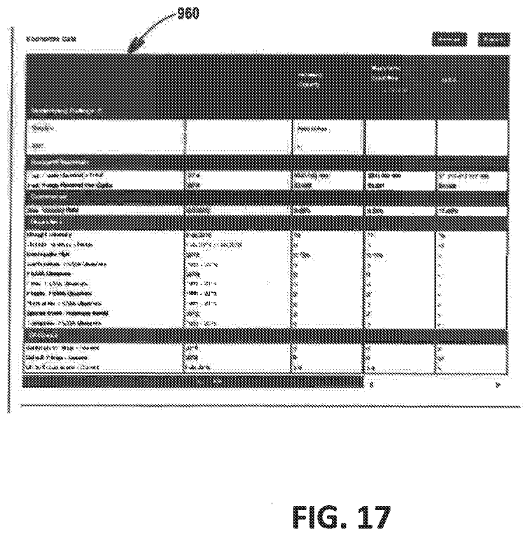

As shown in FIG. 16, the user has selected the “Obligor Profile” tab 412 (FIG. 4) providing the user a report of data from the system database with regard to the obligated party. This data preferably includes the geo-location 950 of the obligor, new sources 952, the DIVER Geo Score 954, credit ratings 956, a debt profile of future maturities by CUSIP, date and a combined debt profile 958, and economic and demographic data 960 for the location of the obligor as well as data for comparable geographies in the obligor's state and across the United States, with reference to the screen shot of FIG. 17.

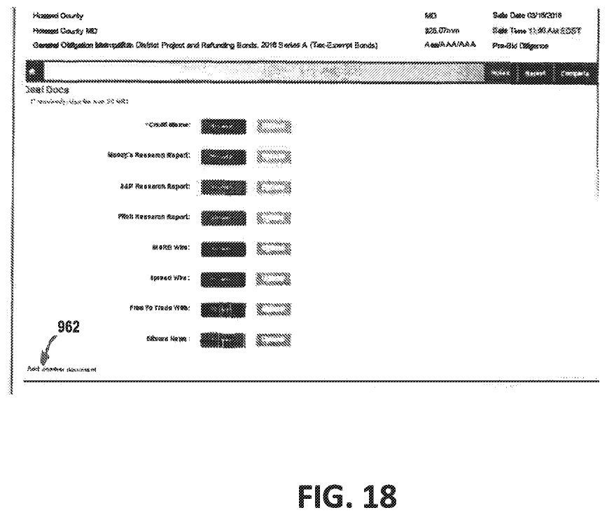

As shown in FIG. 18, the user has selected “Deal Docs” tab 416 (FIG. 4) allowing a user to custom configure which documents are required to be uploaded and stored. The user can, at their discretion, create additional document types at any time by selecting “Add Another Document” 962 allowing them to upload and store relevant deal documents.

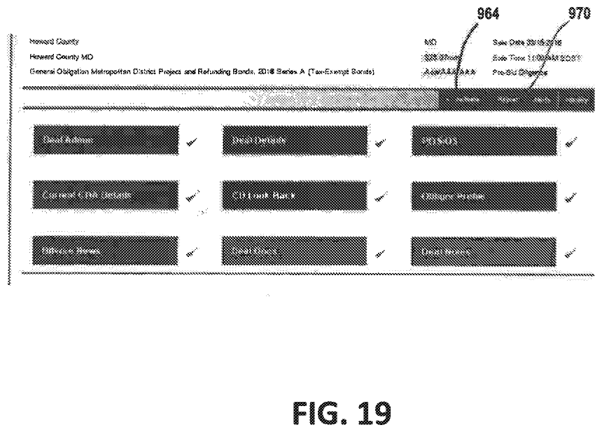

With reference now to FIG. 19, upon a user completing their work, they can select the “Actions” icon 964 and send the deal file to a pre-designated party or parties within their organization for review or designate the deal not to be bid. Once the deal is sent for review/approval, the designated parties receive a notification of the pending status of the deal. The reviewer/approver can approve the deal for bid or send it back for additional diligence.

It is to be further appreciated and understood that upon submission of a deal for “approval”, the deal “file” will be routed to the pre-determined chain of command for file review and approval. For instance, and with regards to Approved/Rejected Deal once a deal is Approved or Rejected it will move from the “Open Deals” to an “Approved” or “Rejected” box in accordance with an illustrated embodiment, it is to be appreciated that if a deal is Approved, the file stays open pending outcome of whether the user actually wins the deal. And if the user wins the deal the user enters additional details and final documents—the user appends final OS filed with the MSRB or the same can be auto-populated. With reference to FIG. 19, the user can select “report” 970 and select a pre-set template, sections or the entire deal file to be generated as a PDF report with active links to all documents that are part of the deal file.

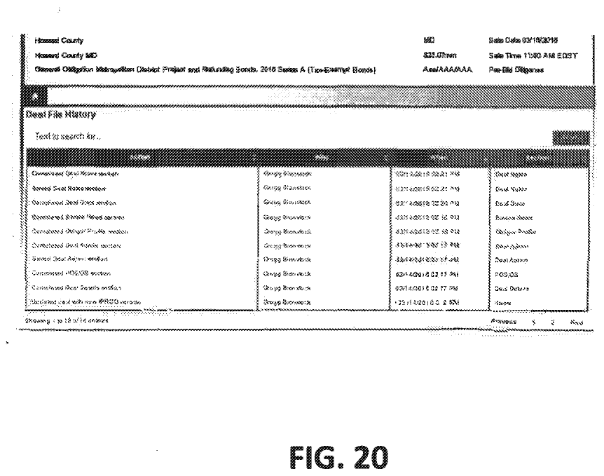

With the above system and process described in accordance with one or more illustrated embodiments, it is to be understood and appreciated that for each step of the described system and process, the deal file is stored and its integrity maintained unless changed by a user. With reference to FIG. 19, the user can select “History” and, as shown in FIG. 20, all actions taken by a user are tracked to demonstrate the workflow and responsible party for each part of the transaction. Deal Files are stored and can be accessed for review and for users to re-use their work by way of permissioned-import for subsequent deals by the same obligated party allowing them to leverage work previously done and stored.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer system for performing underwriting diligence actions relating to municipal bonds, comprising:
a memory configured to store instructions;
a processor in communication with said memory, wherein said processor upon execution of the instructions is configured to:
receive data access to a forward deal calendar database that collects and stores municipal bond deal information from devices connected to a computer system in response to inputs to the devices, the municipal bond deal information including occurrences of events being associated with activities related to municipal bond deals and diligence actions on a data store;
provide an interface to a user for configuring the events configured to:
select from a plurality of municipal bonds transactions using one or more of the following criteria: date; deal type; bond or note; and geographic location; and
access data relating to deals in progress including access to pre-populated and auto-populated information.

2. A computer system as recited in claim 1, wherein the provided data access further enables a user with data access to data relating to one or more of the following: deals in progress; deals to be underwritten; and deals previously underwritten within a user's organization.

3. A computer system as recited in claim 1, wherein the provided data access further enables a user with data access to data relating to New Deals not listed on the calendar whereby the user identifies the obligated party and issuer.

4. (canceled)

5. A computer system as recited in claim 3, wherein the user is enabled to enter data regarding a deal relating to their role, participation and deal participants.

6. A computer system as recited in claim 1, wherein the provided data access further enables a user with data access to data containing information regarding a current deal including one or more of the following: series size, description, ratings, tax status, bank qualified, insurance, dated date, interest date, delivery date, interest type, bond form and security type.

7. A computer system as recited in claim 1, wherein the provided data access further enables a user with data access to data containing information containing one or more of: Preliminary Official Statements (POS) and Official Statements (OS) data.

8. A computer system as recited in claim 7, wherein a user is enabled to upload at least one of POS and OS data.

9. A computer system as recited in claim 1, wherein the provided data access further enables a user with access to a Continuing Disclosure Agreement detail database wherein the user is enabled to enter information associated with representations and requirements set forth in a deal.

10. A computer system as recited in claim 9, wherein the Continuing Disclosure Agreement detail database is auto-populated with information relating to a continuing disclosure obligated party and subject of disclosure obligations when the offering document contains a Continuing Disclosure Agreement section.

11. A computer system as recited in claim 1, wherein the provided data access further enables a user with access to a Continuing Disclosure Look Back database identifying Continuing Disclosure Obligated Parties including relevant Continuing Disclosure Obligated Party representations.

12. A computer system as recited in claim 1, wherein the provided data access further enables a user with access to an Obligor Profile database providing a user a report of data with regards to an obligated party.

13. A computer system as recited in claim 12, wherein the Obligor Profile database contains information relating to one or more of: a geo-location of the obligor, new sources, credit ratings, and department profile of future maturities.
